(19) United States
(12) Patent Application Publication
(10) Pub. No.: US 2005/0093290 A1
(43) Pub. Date: May 5, 2005

(54) DIVIDER WITH MOVABLE TAB

(76) Inventor: Kenneth P. Richied, Liberty Township, OH (US)

Correspondence Address: Mark P. Levy, Esq.;Thompson Hine LLP, 2000 Courthuse Plaza NE, 10 W. Second Street, Dayton, OH, 45402-1758, US

(21) Appl. No.: 10/696,499

(22) Filed: Oct. 29, 2003

(51) Int. Cl. B42F 21/00

(52) U.S. Cl. 283/36

(57) ABSTRACT

A divider including generally flat body portion and a tab coupled to and slidable along an outer edge of said body portion. The tab is manually slidable along the outer edge such that a user can slide the tab to a desired location and release the tab whereupon the tab interacts with the body portion such that the tab is generally locked in place relative to the body portion without requiring any further manual manipulation.

The present invention is directed to a divider, and more particularly, to a divider with a tab movably coupled to an outer edge of the divider.

### BACKGROUND

Dividers are widely used in notebooks, binders and the like to divide the notebook or binder into discrete segments for quick and easy access or to identify certain portions of the notebook or binder. Such dividers may include a tab which extends generally outwardly from the main body portion of the divider so that a user can quickly identify and utilize the divider. However, many such dividers have a tab which is located at a fixed predetermined position of the divider which limits the usefulness of dividers used in a single notebook or binder, and/or requires a user to obtain a replacement divider should a divider having a different tab placement be desired.

Accordingly, there is a need for a divider having a movable tab component wherein the tab component can be securely retained in place.

### SUMMARY

In one embodiment, the present invention is a divider including a generally flat body portion and a tab slidably or movably coupled to the body portion. The tab can be releasably coupled to, or generally locked in place relative to, the body portion in a quick and easy manner so that the divider can be easily adjusted to the desired configuration.

In particular, in one embodiment the invention is a divider including generally flat body portion and a tab coupled to and slidable along an outer edge of said body portion. The tab is manually slidable along the outer edge such that a user can slide the tab to a desired location and release the tab whereupon the tab interacts with the body portion such that the tab is generally locked in place relative to the body portion without requiring any further manual manipulation. Other objects and advantages of the present invention will be apparent from the following description and the accompanying drawings.

### BRIEF DESCRIPTION OF THE DRAWINGS

FIG. 1 is a front view of one embodiment of the divider of the present invention, with the divider mounted in a binder;

FIG. 2 is a rear view of the divider of FIG. 1;

FIG. 3 is a rear view of the divider of FIG. 1, with the tab moved to a different location;

FIG. 4 is a side cross section of the outer edge and tab of the divider of FIG. 1, with the tab locked in place;

FIG. 5 is a side cross section of the tab and divider of FIG. 4, with the tab not locked in place;

FIG. 6 is a front view of the track of the divider of FIG. 1;

FIG. 7 is an end view of the track of FIG. 6;

FIG. 8 is a rear view of the tab of the divider of FIG. 1; and

FIG. 9 is a front perspective view of the tab and track of FIG. 4, with the track shown in hidden lines.

### DETAILED DESCRIPTION

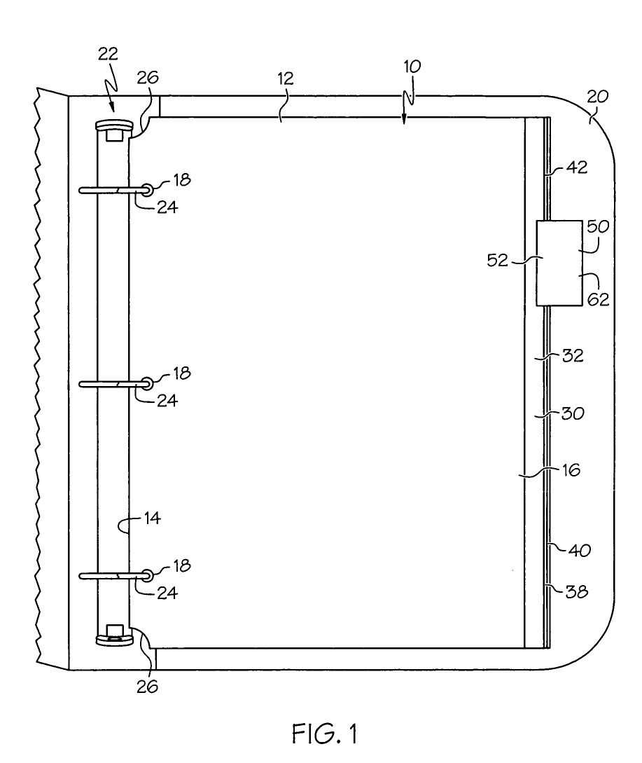

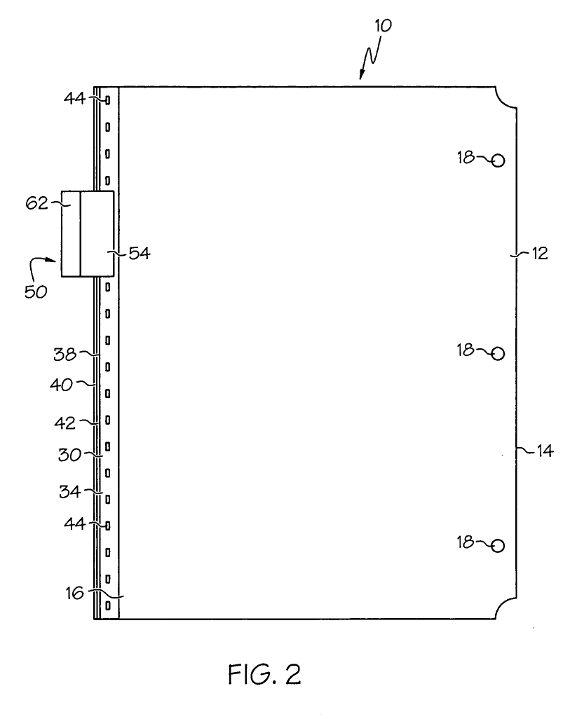

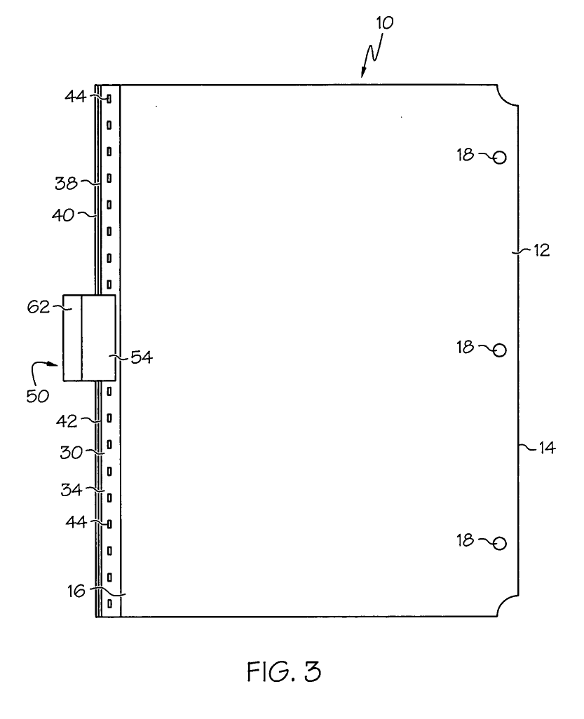

As shown in FIG. 1, the divider of the present invention, generally designated 10, may include a generally flat, planar body portion 12. The body portion 12 may be made of nearly any desired material, such as cardboard, paper, plastic materials, combinations thereof, or other materials. The body portion 12 may have an inner edge 14 and an outer edge 16, and may have a set of holes or openings located 18 adjacent to and extending generally parallel to the inner edge 14. The holes 18 may be sized and spaced to cooperate with a standard binding mechanism so that the divider 10 can be coupled to the binding mechanism. For example, as shown in FIG. 1, a binder 20 may have a three-ring binding mechanism 22 having a set of separable rings or prong components 24. The holes 18 are spaced and located to receive a ring 24 therethrough. Of course, the holes 18 may be arranged to cooperate with various other binding mechanisms (i.e., coil or spiral binding mechanisms, etc.) or, if desired, the holes 18 may be omitted. The inner edge 14 of the body portion 12 may include a set of corner cutouts 26 to reduce interference of the body portion 12 with the binding mechanism 22.

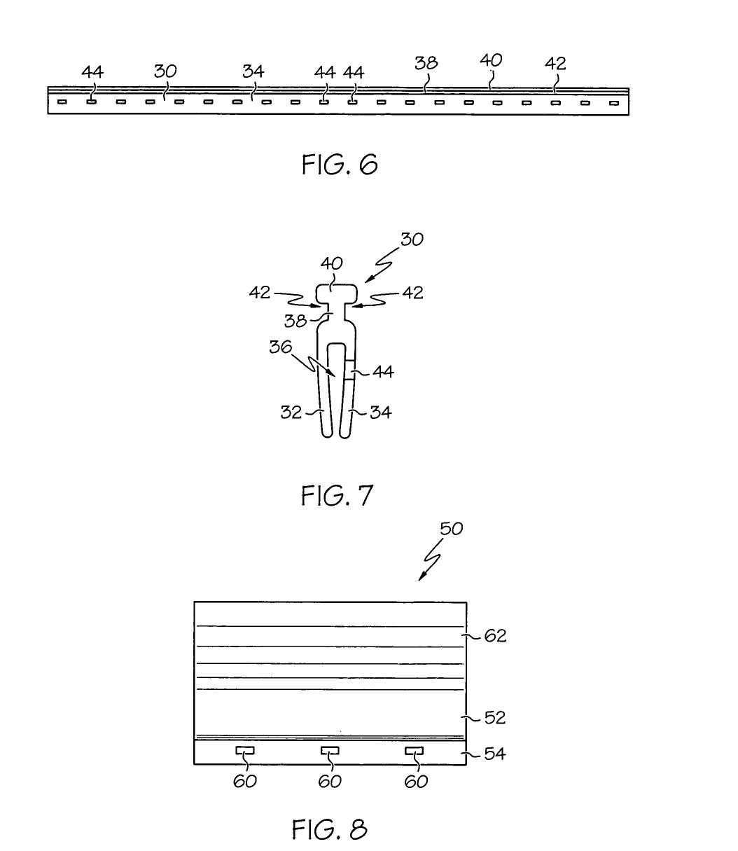

The body portion 12 may include a track 30 coupled to the outer edge or attachment edge 16. As shown in FIGS. 6 and 7, the track 30 may include a pair of spaced generally parallel legs 32, 34 defining a body cavity or body channel 36 therebetween. The upper portion of the track 30 may be generally “T”-shaped in cross section having a relatively narrow neck 38 and a relatively wide head 40 coupled to the neck. In this manner, the track 30 includes a pair of opposed slits or slide guide recesses 42 located adjacent the neck 38 and between the upper portions of the legs 32, 34 and the head 40. One of the legs 34 may have a plurality of openings or recesses 44 formed therein or therethrough. In the illustrated embodiment, the openings 44 are generally rectangular in front view and are equally spaced apart from each other.

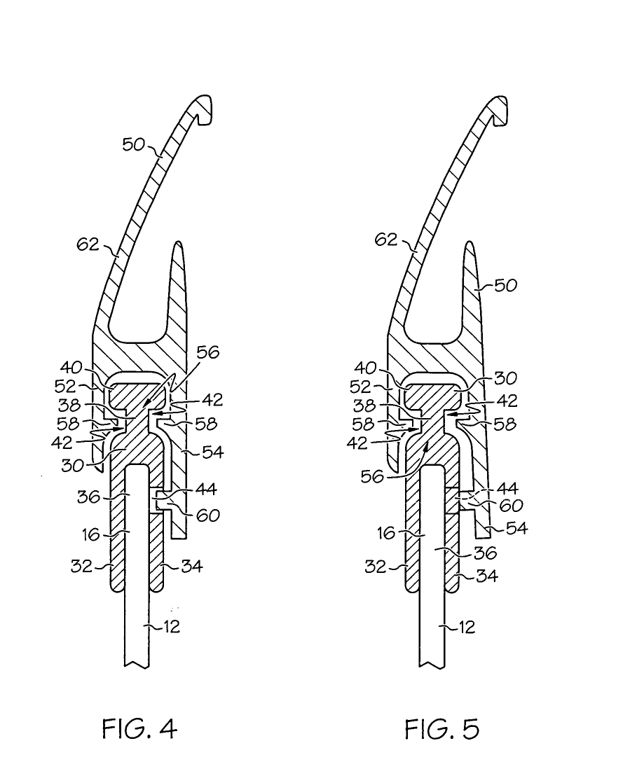

As shown in FIGS. 4 and 5, the track 30 may be coupled to or form part of the body portion 12 by fitting the body cavity 36 over the outer edge 16 of the body portion 12. The track 30 may be coupled to the body portion 12 by friction forces and/or by the spring force of the legs 32, 34 (as can be seen in FIG. 7, the legs 32, 34 are biased inwardly and towards each other). Furthermore, various fastening means, such as adhesives and mechanical fasteners may be used to secure the track 30 to the body portion 12.

The divider 10 may include a tab 50 which is generally co-planar with the body portion 12 and is movably or slidably coupled to the body portion 12. The tab 50 may protrude generally outwardly from the body portion 12. As best shown in FIGS. 4, 5 and 8, the tab 50 may have a pair of spaced walls or legs (i.e., a short wall or leg 52 and a long wall or leg 54) defining a track cavity or track channel 56 therebetween. Each leg 52, 54 may include a slide guide or extension 58 extending into the track cavity 56. The long leg 54 may include a plurality of protrusions 60 extending generally inwardly. As shown in FIG. 8, each of the protrusions 60 may be generally square in front view. Each of the protrusions 60 preferably has a shape generally corresponding to the openings 44 such that each protrusion 60 can be received in an opening 44. Furthermore, each of the protrusions 60 is preferably spaced apart the same distance as the openings 44 such that each protrusion 60 can be simultaneously received in an opening 44. Each of the protrusions 60 and openings 44 are spaced apart in a direction generally parallel to the outer edge 16.

The tab 50 may include a generally upwardly-extending label portion 62. The label portion may be shaped and located to receive a label (not shown) thereon. For example, the label may be an adhesive-backed paper label which can adhere to the label portion 62. The label portion may also include a cavity (not shown) with a generally transparent outer portion such that that a label can be removably inserted into the label portion 62. In this manner, the label portion 62 of the tab 50 enables a user to identify the tab 50 and/or divider 10. Furthermore, or in the alternative, the label portion 62 may be made of a colored, textured or otherwise visually distinct material which may have a visual property different from the body portion 12.

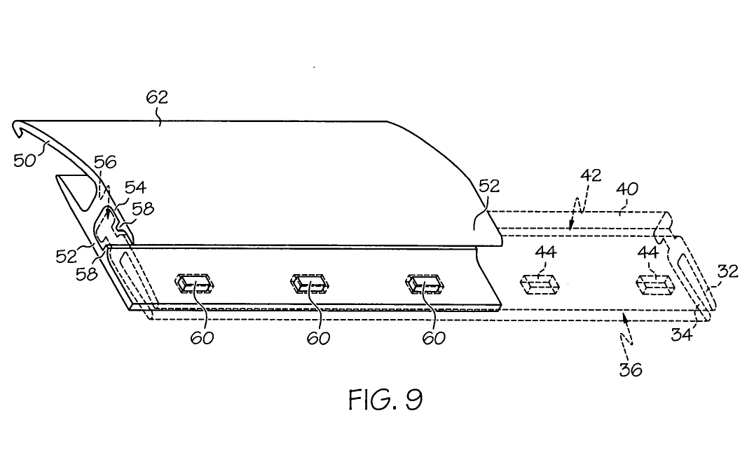

As shown in FIGS. 4 and 5, the tab 50 may be coupled to the track 30 and body portion 12 by urging the head 40 into the track channel 56 such that the slide guides 58 are received in the slits 42 to slidably couple the tab 50 to the track 30. Furthermore, as noted above, each of the protrusions 60 may be shaped and located to be received in an opening 44, as shown in FIGS. 4 and 9. In this manner, the tab 50 may be generally locked in place relative to the body portion 12 when each of the protrusions 60 is received in a corresponding opening 44.

When it is desired to move the tab 50 to a different location along the outer edge 16, a user grasps the tab 50 and moves the tab 50 along the outer edge 16 in the direction of desired positioning. Upon the application of sufficient force, each protrusion 60 is urged out of the corresponding opening 44, as shown in FIG. 5, such that the tab 50 is in its unlocked position. When the tab 50 is in its unlocked position, the long leg 54 is generally moved away from the short leg 52 to accommodate the outward motion of the protrusions 60. Thus, the long leg 54 is deflected away from the short leg 52 in order to allow the protrusions 60 to be spaced away from the openings 44 in a direction of the thickness of the tab 50 (i.e., in a left-to-right direction in FIG. 5). When the tab 50 is in its locked position, it may resist movement along the body portion 12 when the tab 50 is exposed to various forces such as jostling or shifting (i.e. when a notebook including the divider 10 being dropped in a desk or carried in a backpack) but is able to be moved to its unlocked position upon sufficient manual force.

After being moved to its unlocked position, the tab 50 is then free to slide along the track 30, as guided by the interaction of the slide guides 58 and track 30. The protrusions 60/openings 44 may be shaped and arranged such that as the tab 50 is slid along the track 30 at a sufficiently high speed, the protrusions 60 do not engage (i.e., are not received in) the openings 44. Alternately, the protrusions 60 and openings 44 may be shaped such that the protrusions 60 engage the openings 44 at each location such that the tab 50 moves in an “indexing” fashion.

When the tab 50 is located in the desired position, the tab 50 may be adjusted (i.e., rocked back and forth slightly) if necessary to ensure that each protrusion 60 is fully received in an opening 44 to generally lock the tab 50 in place. However, the protrusions 60 and openings 44 may be spaced relatively close together such that the protrusions 60 are received in openings 44 at nearly all locations of the tab 50 along the track. Alternately, a user can slowly slide the tab 50 as the tab 50 approaches its desired location, and then visually, audibly, or by feel confirm that the tab 50 is locked in place when the protrusions 60 are receiving in the openings 44. In this manner, the tab 50 can simply moved to the desired location (i.e., moved along the track 30) and released so that the tab 50 is generally locked in place without requiring any further manual manipulation.

Thus, the force required to unlock the tab 50 and body portion 12 (i.e., move the protrusions 60 out of the openings 44) may be greater than the force required to slide the tab 50 along the body portion 12 when the tab 50 is not locked in place. In other words, the force required to slide the tab 50 along the track 30, when starting from a rest position when the tab 50 is in an unlocked position (FIG. 5) is less than the force required to slide the tab 50 along the track 30 from a rest position when the tab 50 is in its locked position (FIG. 4). The force required to unlock the tab 50 may be greater than about 0.10 lbs, or about 0.25 lbs, or about 0.50 lbs. or about 0.75 lbs, or about 1 lbs. or about 2 lbs, or about 3 lbs, or about 4 lbs, or about 5 lbs, or about 10 lbs.

In the embodiment described above, the tab 50 includes the protrusions 60 and the track 30 includes the openings 44 therein. However, these configurations may be reversed as desired. For example, the track 30 may include the protrusions 60 and the tab 50 may include the openings 44. Furthermore, the male/female orientation of the track 30 and tab 50 may be reversed. For example, the track 30 may include a tab cavity or channel which receives a protrusion or portion of the tab 50 therein. Further, instead of a plurality of protrusions 60, the tab 50 may include only a single protrusion.

Having described the invention in detail and by reference to the preferred embodiments, it will be apparent that modifications and variations thereof are possible without departing from the scope of the invention.

1. A divider comprising:
generally flat body portion; and
a tab coupled to and slidable along an outer edge of said body portion, said tab being manually slidable along said outer edge such that a user can slide said tab to a desired location and release said tab whereupon said tab interacts with said body portion such, that said tab is generally locked in place relative to said body portion without requiring any further manual manipulation and wherein at least one of said body portion or said tab includes a plurality of openings and the other one of said body portion or said tab includes at least one protrusion, said protrusion being shaped to be received in one of said openings to generally lock said tab in place relative to said body portion.

2. The divider of claim 1 wherein said tab is generally co-planar with said body portion.

3. The divider of claim 1 wherein said tab includes a label portion that is shaped and located to receive a label therein.

4. The divider of claim 1 wherein said body portion is generally rectangular in top view.

5. The divider of claim 1 wherein said body portion includes a set of attachment holes located adjacent to an inner edge located generally opposite said outer edge.

6. The divider of claim 1 wherein said tab fits over said outer edge.

7. (Canceled)

8. The divider of claim 1 wherein said one of said body portion or tab includes a plurality of protrusions which are spaced apart in a direction generally parallel to said outer edge.

9. The divider of claim 8 wherein each protrusion is generally rectangular in top view.

10. The divider of claim 1 wherein said body portion includes a track fixedly coupled to said outer edge, said track including said one of said at least one protrusion or said plurality of openings of said body portion.

11. The divider of claim 1 wherein one of said tab or body portion includes a channel shaped to fit over an attachment edge of the other one of said tab or body portion.

12. The divider of claim 11 wherein said channel is generally defined by a pair of generally parallel walls which are oriented generally parallel with said body portion.

13. The divider of claim 12 wherein at least one of said walls can be deflected away from the other one of said walls to allow said protrusion to be moved away from an opening.

14. The divider of claim 11 wherein said one of said tab or body portion includes a pair of opposed slide guides extending into said channel, each slide guide being received in an associated slide guide recess on the other one of said tab or body portion.

15. A divider comprising:
generally flat body portion; and
a tab coupled to and slidable along an outer edge of said body portion, said tab being manually slidable along said outer edge such that a user can slide said tab to a desired location and release said tab whereupon said tab interacts with said body portion such that said tab is generally locked in place relative to said body portion without requiring any further manual manipulation wherein one of said tab or body portion includes a plurality of recesses located along said outer edge.

16. The divider of claim 1 wherein said tab protrudes generally outwardly from said body portion.

17. The divider of claim l wherein said tab is movable between a locked position wherein said tab is generally locked in place relative to said body portion and an unlocked position wherein said tab is not generally locked in place relative to said body portion.

18. The divider of claim 17 wherein the force required to move said tab from said locked position to said unlocked position is greater than the force required to slide said tab along said body portion when said tab is in said unlocked position.

19. The divider of claim 17 wherein the force required to slide said tab along said body from a rest position when said tab is in said unlocked position is less than the force required to slide said tab along said body from a rest position when said tab is in said locked position.

20. The divider of claim 1 wherein said tab releasably grips said attachment edge.

21. (Canceled)

22. A divider comprising:
a generally flat sheet-like body portion having an outer edge with a plurality of openings extending therealong, said openings being spaced apart in a direction extending generally parallel to said outer edge; and
a tab coupled to and slidable along said outer edge of said body portion, said tab being generally co-planar with said body portion and protruding generally outwardly from said body portion, said tab including a plurality of protrusions shaped to be received in one of said openings and having a channel defined by a pair of generally parallel walls which are generally parallel with said body portion and which receive said outer edge therebetween, wherein at least one of said walls can be deflected away from the other one of said walls in order to allow a protrusion to be moved away from said openings such that said tab is manually slidable along said outer edge such that a user can slide said tab to a desired location and release said tab whereupon said protrusions interact with said openings such that said tab is generally locked in place relative to said body portion without requiring any further manual manipulation.

23. A method for manipulating a tab divider comprising:
providing a divider including a body portion and a tab coupled to and slidable along an outer edge of said body portion;
manually sliding said tab along said outer edge until said tab is located at a desired location; and
releasing said tab whereupon said tab interacts with said body portion such that said tab is generally locked in place relative to said body portion without requiring any further manual manipulation wherein at least one of said body portion or said tab includes a plurality of openings and the other one of said body portion or said tab includes a plurality of protrusions, each protrusion being shaped to be received in one of said openings to generally lock said tab in place relative to said body portion during said releasing step.

24. The method of claim 23 further comprising the step of unlocking said tab relative to said body portion and again manually sliding said tab along said outer edge, and wherein the force required to unlock said tab relative to said body portion is greater than the force required to slide said tab along said body portion.

25. The method of claim 23 wherein said tab is movable between a locked position wherein said tab is generally locked in place relative to said body portion and an unlocked position wherein said tab is not generally locked in place relative to said body portion, and wherein said releasing step includes moving said tab to said locked position.

26. The method of claim 25 further including the step of moving said tab to said unlocked position, and wherein the force required to slide said tab along said body from a rest position when said tab is in an unlocked position is less than the force required to slide said tab along said body from a rest position when said tab is in its locked position.

27. (Canceled)
